(19) United States
(12) Patent Application Publication
(10) Pub. No.: US 2016/0349895 A1
(43) Pub. Date: Dec. 1, 2016

(54) TOUCH PANEL AND TOUCH DISPLAY DEVICE

(71) Applicant: SHENZHEN CHINA STAR OPTOELECTRONICS TECHNOLOGY CO., LTD., Shenzhen City, Guangdong (CN)

(72) Inventors: Chong LONG, Shenzhen, Guangdong (CN); Zhiyuan SHEN, Shenzhen, Guangdong (CN); Tao SONG, Shenzhen, Guangdong (CN)

(73) Assignee: Shenzhen China Star Optoelectronics Technology Co., Ltd., Shenzhen, Guangdong (CN)

(21) Appl. No.: 14/426,158

(22) PCT Filed: Dec. 2, 2014
(86) PCT No.: PCT/CN2014/092776

§ 371 Date: Mar. 4, 2015

(30) Foreign Application Priority Data
Nov. 24, 2014 (CN) 201410682975.7

(51) Int. Cl. G06F 3/041; G02F 1/1333; G06F 3/044

(52) U.S. Cl. CPC G06F 3/0416; G06F 3/044; G06F 3/0412; G02F 1/13338; G06F 2203/04103

(57) ABSTRACT

A touch panel and a touch display device are disclosed. The touch panel comprises a controller and a plurality of the touch electrodes arranged in a matrix, and each of the touch electrodes connects to a pin of the controller by using at least two wires. Through the above mentioned way, the present invention solves the open circuit issue between the touch electrode and the controller, reduces the defective rate and improves the life time of the touch panel.

### FIELD OF THE INVENTION

The present invention relates to touch technology field; in particular to a touch panel and touch display device.

### BACKGROUND OF THE INVENTION

Touch screens are also called as touch panels, which is a sensor type liquid crystal display device and can receive the input signal from contacting such as finger touching. When touching a graphical buttons, the tactile feedback system on the display makes sure of the action location of the touch according to the pre-set driving scan method. Further, to touch the graphical button is accurately to make sure the order type. Comparing with the conventional technology of the mechanical button panel, the touch panel is more convenient so it is wildly applied.

There are many kinds of the touch panels wildly used, such as a vector pressure sensor touch screen, an infrared grid touch screen, a surface acoustic touch screen and a resistive touch screen. However, in the conventional technology, the capacitance type touch screen is most popular. The capacitive touchscreen technology is that when a finger approaches the capacitive touch panel, it forms the capacitance change. It contains a self-capacitance touch technology and a mutual capacitance touch technology. Using the in-cell self-capacitance touch technology as an example, the plurality of the touch electrodes are made by the transparent conductive material on the glass surface. These touch electrodes are connected with the controller by using the wires. The touch electrodes respectively form capacities to the ground. This is usually called as self-capacitance. When the finger touches the touch screen, the finger capacity will add to the capacity on the screen to increase the capacity of the touch screen. According to the change of the capacity before and after touching, the touch location can be detected.

However, in the convention art, the touch electrode uses one wire to connect with the controller, as shown in FIG. 1. The wire 103 is used to connect between the touch electrode 101 and the controller 102. But in the manufacturing process of the touch panel, the panel generally needs the exposure technology. In the exposure technology, the dust, foreign matter some particles or the large amount of static electricity causes the open circuit to result in the touch electrode being failure because of the open circuit in the single line. Moreover, there is not any detection method for the fail touch electrode. It brings the hidden worry to the user undoubtedly.

### SUMMARY OF THE INVENTION

The present invention provides a touch panel and touch display device mainly for solving the problem which solves the open circuit being between the touch electrodes and the controller efficiently. The present invention reduces the defective rate and also enhances the life time of the touch panel.

In order to solve the mentioned technical problem, the present invention is to provide a touch panel, and the touch panel comprises a controller and a plurality of touch electrodes arranged in a matrix, each of the touch electrodes connects to a pin of the controller by at least two wires, the touch electrodes are nano indium tin metal oxide (ITO) electrodes, and the touch panel is a self-capacitance touch panel.

According to a preferred embodiment of the present invention, at least the two wires electrically connecting between each of the touch electrodes and the controller are in one layer.

According to a preferred embodiment of the present invention, at least the two wires electrically connecting between each of the touch electrodes and the controller are in different layers.

In order to solve the technical problem, the present invention adopts the technical solution which is to provide a touch panel, wherein the touch panel comprises a controller and a plurality of touch electrodes arranged in a matrix, and each of the touch electrodes connects to a pin of the controller by at least two wires.

According to a preferred embodiment of the present invention, the touch electrodes are nano indium tin metal oxide (ITO) electrodes.

According to a preferred embodiment of the present invention, at least the two wires electrically connecting between each of the touch electrodes and the controller are in one layer.

According to a preferred embodiment of the present invention, at least the two wires electrically connecting between each of the touch electrodes and the controller are in different layers.

According to a preferred embodiment of the present invention, the touch panel is a self-capacitance touch panel.

In order to solve the technical problem, the present invention adopts the technical solution which is to provide a touch display device, wherein the touch display device comprises a touch panel, the touch panel comprises a controller and a plurality of touch electrodes arranged in a matrix, and each of the touch electrodes connects to a pin of the controller by at least two wires.

According to a preferred embodiment of the present invention, the touch electrodes are nano indium tin metal oxide (ITO) electrodes.

According to a preferred embodiment of the present invention, at least the two wires electrically connecting between each of the touch electrodes and the controller are in one layer.

According to a preferred embodiment of the present invention, at least the two wires electrically connecting between each of the touch electrodes and the controller are in different layers.

According to a preferred embodiment of the present invention, the touch panel is a self-capacitance touch panel.

The advantages of the present invention are: comparing with the convention technology, the touch electrodes of the touch panel of the present invention respectively connect to the controller by at least two wires. Even though the single wire appears an open circuit or other anomalies, the electric connection between the touch electrode and the controller is still achieved by the other wire. The present invention reduces the anomalies resulting from the wire, such as an open circuit, to reduce the product defect rate and to save the pin resource of the controller. Moreover, the product life time can be also prolonged by using two wires for the electric connection further to save the cost for the users.

### BRIEF DESCRIPTION OF THE DRAWINGS

FIG. 1 is the diagram for the electrical connection between the touch electrode and the controller in the conventional art;

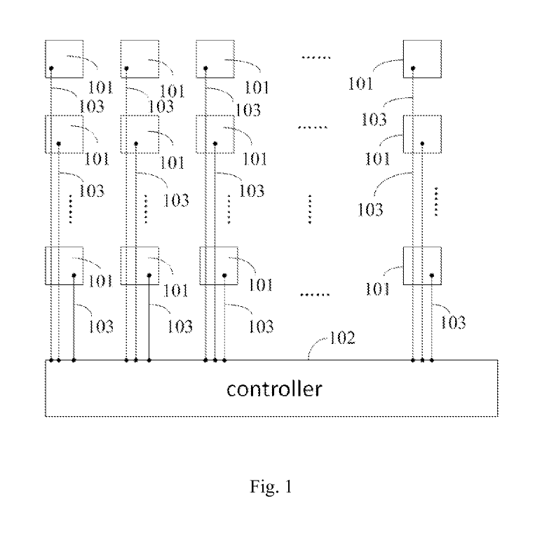

FIG. 2 is the structural diagram of one embodiment of the touch panel of the present invention;

FIG. 3 is the structural diagram of a specific embodiment of the touch panel shown in FIG. 2;

FIG. 4 is the structural diagram of the other embodiment of the touch panel of the present invention;

FIG. 5 is the structural diagram of one embodiment of the touch display device of the present invention.

### DETAILED DESCRIPTION OF THE PREFERRED EMBODIMENTS

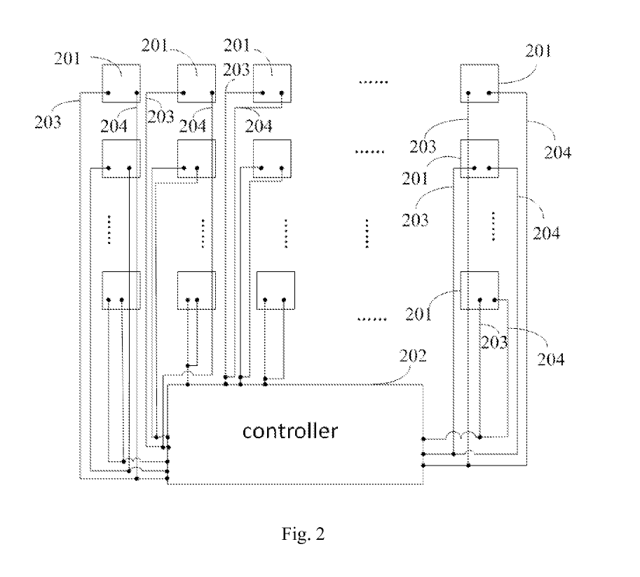

Please refer to FIG. 2 which is the structural diagram based on one embodiment of the touch panel of the present invention. The touch panel based on the embodiment of the present invention is an in-cell self-capacitance touch panel. In this embodiment, the touch panel comprises a plurality of the touch electrodes 201 arranged in a matrix and the controller 202. In this embodiment, the touch electrodes 201 are nano indium tin metal oxide (ITO) electrodes.

Where, at least the two wires electrically connecting between each of the touch electrodes 201 and the controller 202 are in one layer. As shown in FIG. 2, in the embodiment, each of the touch electrodes 201 connects to the controller 202 through the two wires 203 and 204.

In order to simplify the touch panel, and clarify the circuit, in the preferred embodiment, the wires 203 and 204 are respectively disposed in the different layers of the circuit board where the touch electrodes are arranged. For example, if the circuit board where the touch electrodes 201 is disposed is four laminates, the wire 203 can disposed in the first laminate and the wire 204 can be disposed in the fourth laminate.

However, because the resolution of the touch panel is lower than the resolution of the display pixel in the normal condition, the wiring space of the touch panel is more sufficient. Therefore, in the other embodiment, the wires 203 and 204 are disposed in the same layer of the circuit board where the touch electrodes 201 are arranged.

Further, as shown in FIG. 2, in order to save the pin amount of the controller 202, and reduce the pin loading of the controller 202, preferably, the two wires 202, 203 connecting with the touch electrode 201 and the controller 202 and the pin of the controller 202 converge into one wire which connects to the same pin of the controller 202.

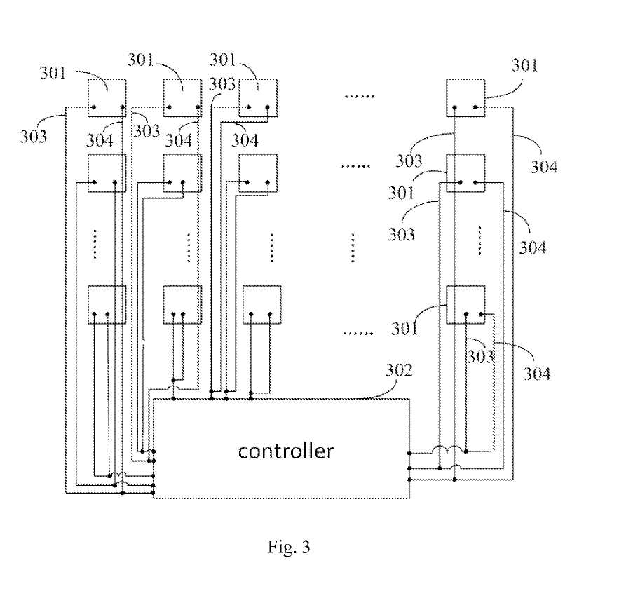

When the touch panel operates, the touch electrodes 201 respectively form capacitors to the ground. The controller 202 scans the touch electrodes 201 by using the power (not shown in Figs), and in other words the touch electrodes 201 are charged and discharged through the wires 203, 204. When the user touches the touch panel, the touch panel forms the capacitor to the human body because the human body belongs to a conductor. And then it influences the value of the self-capacitance between the touch electrodes 201 and the ground. The location where the touch electrodes 201 have different capacitance value can be detected to make sure where the user touches the panel. Even when the single wire has an error, the other wire can still transit the signal continuously for the touch electrodes and the controller, as shown in FIG. 3. When the error appears in the left wire 303 in the second row and second column of the touch electrodes 301, such as short circuit or poor contact, the right wire 304 can still transit the signal for the touch electrode and the controller. The touch panel still operates normally and also saves the pin resource of the controller.

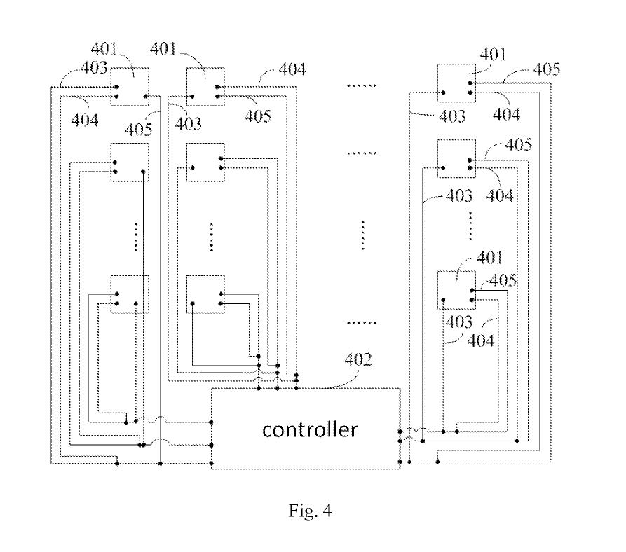

In the other embodiment, as shown in FIG. 4, each of the touch electrodes 401 connects to the controller 402 through the three wires 403, 404 and 405. Further, as shown in FIG. 4, in order to save the pin of the controller 402, and reduce the pin loading of the controller 402, preferably, the three wires 303, 304 and 305 connecting with the controller 402 converges into one wire in the pin of the controller 402 and connects to the same pin of the controller 402. Even when there is an error in one wire, the other two wires can continuously transit the signal for the touch electrode and the controller without affecting the touch panel operation and save the pin resource of the controller.

The other embodiment can use four, five or even more wires, and the plurality wires relative to the single touch electrode converge into one wire in the pin of the controller, and connect to the same pin of the controller. The wire amount is not limited herein. Because the cost of the wire addition is much lower than the cost for the panel exchange, the above mentioned technology reduces the effect which the error happens between the touch electrode and the controller and affects the touch panel operation without increasing any cost and manufacture process to improve the operation of the touch panel.

It should be noted that, the touch panel in the embodiment is an in-cell self-capacitance touch panel. In the other type touch panels, the scope of the present invention comprises the solution which over one wire connects with the touch electrode and the controller, this does not enumerate.

Comparing with the conventional art, the touch panel of the embodiment comprises the controller and the plurality of touch electrodes arranged in the matrix. Each of the touch electrodes uses at least two jumpers to connect with the same pin of the controller. Even though the single wire appears an open circuit or other anomalies, the electric connection between the touch electrode and the controller is still achieved by the other wire. The present invention reduces the anomalies resulting from the wire, such as an open circuit, to reduce the product defect rate and to save the pin resource of the controller. Moreover, the product life time can be also prolonged by using two wires for the electric connection further to save the cost for the users.

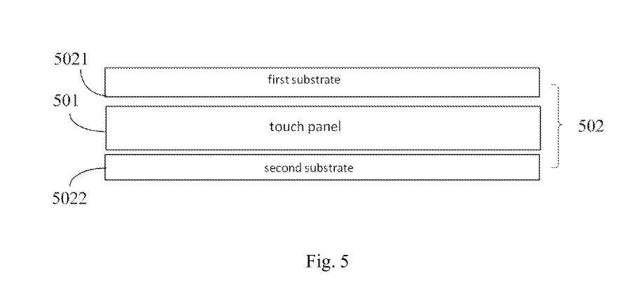

Refer to FIG. 5 which is the structural diagram of the embodiment of the touch display device of the present invention. The display device of the embodiment comprises a touch panel 501 and a liquid crystal assembly 502 where the liquid crystal assembly comprises a first substrate 5021 and a second substrate 5022 and a LC layer (not shown in figures) disposed between the first substrate 5021 and the second substrate 5022. It should be noted that the touch panel 501 and the liquid crystal assembly 502 are set in opposition in FIG. 5. According to the different kinds of capacitance type touch display device, the arrangement of the touch panel and the liquid crystal assembly can be different. The above mentioned position is one example, but it cannot limit the scope of the present invention.

The touch panel of the embodiment is an in-cell self-capacitance touch panel. The touch panel of the embodiment comprises the plurality of touch electrodes arranged in the matrix and the controller. In the embodiment, the touch electrodes are nano indium tin metal oxide (ITO) electrodes.

Where, at least two wires is used to connect between each of the touch panel and the controller. In the embodiment, two wires is used to connect between each of the touch electrodes and the controller. In order to simplify the touch panel and clarify the circuit, in the preferred embodiment, the two wires connecting with the same touch electrode and the controller are respectively arranged in the different layers of the circuit board where the touch electrodes are arranged. For example, if the circuit board of the touch panel is four laminates, one wire can be disposed in the first layer and the other wire can be disposed in the fourth layer.

However, because the resolution of the touch electrode is lower the resolution of the display pixel in the general circumstances, the wiring space of the touch panel is more sufficient. Therefore, in the other embodiment, the two wires can also be arranged in the same layer of the circuit board where the touch electrodes are arranged. For example, if the circuit board of the touch panel is four laminates, the two wires can be disposed in the first layer of the circuit board or the fourth layer of the circuit board.

In order to save the pin of the controller and reduce the pin loading of the controller, preferably, the two wires which connect between the touch electrode and the controller converge into one wire near by the pin of the controller, which the wire connects electrically to the pin.

When the touch panel operates, each of the touch electrodes respectively forms self-capacitance to the ground. The controller scans each of the touch electrodes by using the power (not shown in figures), and in other words the touch electrodes are charged and discharged through the two wires. When the user touches the touch panel, the touch panel forms the capacitor to the human body because the human body belongs to a conductor. And then it influences the value of the self-capacitance between the touch electrodes and the ground. The location where the touch electrodes 201 have different capacitance value can be detected to make sure where the user touches the panel. Further, the display device shows the touch position icon or the order relative to the display content. When the error appears in the one wire, the other wire can still transit the signal for the touch electrode and the controller. The touch panel still operates normally and also save the pin of the controller.

In the other embodiment, each of the touch electrodes connects to the controller by using over two wires, such as three wires. In order to save the pin of the controller and reduce the pin loading of the controller, preferably each of the touch electrodes connects to the controller by using the three wires which converges into one wire in the pin of the controller and connects electrically with the same pin. If the one wire has the error, one of the other two wires continuously transits the signal of the touch electrode and the controller. The touch panel still operates normally and also saves the pin of the controller.

In another embodiment, the wires can be four wires, five wires or even more wires. The plurality of the wires which connect to one of the touch electrodes converges into one wire in the pin of the controller and connects the same pin. The wire amount is not limited herein. Because the cost of the wire addition is much lower than the cost for the panel exchange, the above mentioned technology reduces the effect which the error happens between the touch electrode and the controller and affects the touch panel operation without increasing any cost and manufacture process. The present invention improves the operation of the touch panel and saves the pin resource of the controller.

It should be noted that, the touch panel in the embodiment is an in-cell self-capacitance touch panel. In the other type touch panels, the scope of the present invention comprises the solution which over one wire connect with the touch electrode and the controller, this does not enumerate.

Comparing with the conventional art, the touch panel of the embodiment comprises the controller and the plurality of touch electrodes arranged in the matrix. Each of the touch electrodes uses at least two jumpers to connect with the same pin of the controller. Even though the single wire appears an open circuit or other anomalies, the electric connection between the touch electrode and the controller is still achieved by the other wire. The present invention reduces the anomalies resulting from the wire issue, such as an open circuit, to reduce the product defect rate and to save the pin resource of the controller. Moreover, the product life time can be also prolonged by using two wires for the electric connection further to save the cost for the users.

The above are only embodiments of the present invention, the patent does not therefore limit the scope of the invention, any use of the accompanying drawings and the description of the present invention is made equivalent structures or equivalent conversion process, either directly or indirectly in the other the relevant art, are included within the same reason the patent scope of the present invention.

What is claimed is:

1. A touch panel, wherein the touch panel comprises a controller and a plurality of touch electrodes arranged in a matrix, each of the touch electrodes connects to a pin of the controller by at least two wires, the touch electrodes are nano indium tin metal oxide (ITO) electrodes, and the touch panel is a self-capacitance touch panel.

2. The touch panel as claimed in claim 1, wherein at least the two wires electrically connecting between each of the touch electrodes and the controller are in one layer.

3. The touch panel as claimed in claim 1, wherein at least the two wires electrically connecting between each of the touch electrodes and the controller are in different layers.

4. A touch panel, wherein the touch panel comprises a controller and a plurality of touch electrodes arranged in a matrix, and each of the touch electrodes connects to a pin of the controller by at least two wires.

5. The touch panel as claimed in claim 4, wherein the touch electrodes are nano indium tin metal oxide (ITO) electrodes.

6. The touch panel as claimed in claim 4, wherein at least the two wires electrically connecting between each of the touch electrodes and the controller are in one layer.

7. The touch panel as claimed in claim 4, wherein at least the two wires electrically connecting between each of the touch electrodes and the controller are in different layers.

8. The touch panel as claimed in claim 4, wherein the touch panel is a self-capacitance touch panel.

9. A touch display device, wherein the touch display device comprises a touch panel, the touch panel comprises a controller and a plurality of touch electrodes arranged in a matrix, and each of the touch electrodes connects to a pin of the controller by at least two wires.

10. The device as claimed in claim 9, wherein the touch electrodes are nano indium tin metal oxide (ITO) electrodes.

11. The device as claimed in claim 9, wherein at least the two wires electrically connecting between each of the touch electrodes and the controller are in one layer.

12. The device as claimed in claim 9, wherein at least the two wires electrically connecting between each of the touch electrodes and the controller are in different layers.

13. The device as claimed in claim 9, wherein the touch panel is a self-capacitance touch panel.
